(19) United States
(12) Patent Application Publication
(10) Pub. No.: US 2004/0162387 A1
(43) Pub. Date: Aug. 19, 2004

(54) One-component coating systems

(76) Inventors: Thorsten Rische, Unna (DE); Martin Melchiors, Leichlingen (DE); Karin Naujoks, Odenthal (DE); Thomas Feller, Solingen (DE); Jurgen Meixner, Krefeld (DE)

Correspondence Address: BAYER POLYMERS LLC, 100 BAYER ROAD, PITTSBURGH, PA, 15205, US

(21) Appl. No.: 10/776,992

(22) Filed: Feb. 11, 2004

(30) Foreign Application Priority Data
Feb. 14, 2003 (DE) 10306243.2

(51) Int. Cl. B05D 3/02; C08L 75/00

(52) U.S. Cl. 524/839; 427/385.5

(57) ABSTRACT

The present invention relates to aqueous one-component (1K) coating systems based on non-isocyanate-reactive polyurethane dispersions (polyurethane dispersions which are not reactive towards isocyanate groups) and blocked, hydrophobic polyisocyanates and also to a process for their preparation and use.

### CROSS REFERENCE TO RELATED PATENT APPLICATION

The present patent application claims the right of priority under 35 U.S.C. §119 (a)-(d) of German Patent Application No.103 06 243.2, filed Feb. 14, 2003.

### FIELD OF THE INVENTION

The present invention relates to aqueous one-component (1K) coating systems based on non-isocyanate-reactive polyurethane dispersions (polyurethane dispersions which are not reactive towards isocyanate groups) and blocked, hydrophobic polyisocyanates and also to a process for their preparation and use.

### BACKGROUND OF THE INVENTION

In the coating of substrates, solvent-borne binders are increasingly being replaced by aqueous, environment-friendly systems. An increasing role is being played in particular by binders based on polyurethane-polyurea dispersions, on account of their excellent properties.

The preparation of aqueous polyurethane (PU) dispersions is known in principle. The various possibilities for preparing such dispersions have been described, for example, by D. Dieterich in a review article (D. Dieterich, Prog. Org. Coatings 9, 281 (1981)).

In order to bring about further improvements in particular properties of these dispersions they are often used in combination with crosslinkers based on blocked polyisocyanates.

WO-A 02/14395, for example, discloses the preparation of coating compositions which are composed of urethane-group-containing polyols and hydrophobic polyisocyanates blocked with pyrazole derivatives. The thermally induced deblocking leads to the crosslinking of polyol and polyisocyanate, with formation of urethane. The resultant coatings are suitable for stone-chip-resistant, yellowing-free coatings.

1K coating systems based on PU dispersions which possess blocked isocyanate groups and no significant amounts of isocyanate-reactive groups can be crosslinked under thermal exposure with the substrate to which they have been applied or into which they have been incorporated.

In many fields of application, therefore, such as in the sizing of glass fibres or the production of glass-fibre-reinforced plastics, for example, use is made of polyurethane-polyurea dispersions containing no isocyanate-reactive groups in combination with blocked water-dispersible or blocked water-soluble polyisocyanates, whose preparation is described, for example, in DE-A 24 56 469 and DE-A 28 53 937.

With the aqueous one-component (1K) coating compositions known from the prior art, however, the stringent requirements, in particular in properties such as water resistance and wet adhesion, are not satisfactorily met.

The object of the present invention was therefore to provide aqueous storage-stable coating systems which following film formation possess a higher water resistance and wet adhesion than conventional, prior art coating compositions.

### SUMMARY OF THE INVENTION

The present invention is directed to aqueous one-component (1K) coating systems that include

(I) at least one polyurethane (A) which contains chemically bonded hydrophilic groups and from 0 to 0.53 mmol/g, based on the nonvolatile fraction of the dispersion, of groups containing Zerewitinov-active hydrogen atoms, and

(II) at least one polyisocyanate (B) in which the NCO groups have been reversibly blocked and which contains no hydrophilic groups, and

(III) water,

the proportion of components (A) and (B) being such that the blocked isocyanate content is between 0.01 and 1.0 mol/100 g resin solids.

The present invention is also directed to a process for preparing aqueous the above-described coating systems including mixing component (B) into the polyurethane (A) prior to dispersing.

The present invention is further directed to a process for producing coatings including applying the above-described coating system to a substrate, where the water is at least partly removed and then thermal curing is carried out.

The present invention is additionally directed to substrates coated with coating compositions containing the above-described (1K) coating systems.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has been found that hydrophobic blocked polyisocyanates can be stably dispersed in water with the aid of water-dispersible and/or water-soluble polyurethanes possessing no significant amounts of Zerewitinov-active hydrogen atoms, and significantly improve the properties of the coating produced from them, such as water resistance and wet adhesion. In this case the water-dispersible or water-soluble polyurethanes fullfil the function of an “emulsifier” for the blocked polyisocyanates. Since the polyurethanes contain no significant amounts of Zerewitinov-active hydrogen atoms they do not form a self-crosslinking dispersion in combination with the blocked polyisocyanates. Following the elimination of the blocking agent at elevated temperature the functional groups of the polyisocyanate crosslinker are able to crosslink with the isocyanate-reactive groups of the substrate to which the coating composition has been applied. In contrast to conventional binder/crosslinker combinations, where binder and crosslinker have been hydrophilicized, the coating compositions of the invention have a very much lower overall hydrophilicity, resulting, following application to a substrate, in significantly lower water absorption, higher water resistance, and better wet adhesion of the coating.

As used herein, the term “Zerewitinov-active hydrogen atom” refers to a hydrogen atom which reacts with an isocyanate moiety under urethane or urea bond-forming conditions, as disclosed in U.S. Pat. No. 3,330,782 to Poppelsdorf (col. 2, lines 44-52, herein incorporated by reference). Non-limiting examples of Zerewitinov-active hydrogen atoms include, but are not limited to alcohols, water, amines, ureas, urethanes, phenols, thiols, and carboxylic acids.

The invention provides aqueous one-component (1K) coating systems comprising

(I) at least one polyurethane (A) which contains chemically bonded hydrophilic groups and from 0 to 0.53 mmol/g, preferably from 0 to 0.4 mmol/g, more preferably from 0 to 0.25 mmol/g, based on the nonvolatile fraction of the dispersion, of groups containing Zerewitinov-active hydrogen atoms, and

(II) at least one polyisocyanate (B) in which the NCO groups have been reversibly blocked and which contains no hydrophilic groups, and

(III) water,

the proportion of components (A) and (B) being such that the blocked isocyanate content is between 0.01 and 1.0 mol/100 g resin solids.

For the purposes of the present invention, groups containing Zerewitinov-active hydrogen atoms are hydroxyl, primary or secondary amine or thiol groups.

In the context of the present invention, ionic or nonionic groups are included under hydrophilic groups.

The polyurethanes (A) suitable for the 1K coating systems of the invention are reaction products of

A1) polyisocyanates,

A2) polymeric polyols and/or polyamines having average molar weights of from 400 to 8000,

A3) optionally mono- or polyalcohols or mono- or polyamines or amino alcohols having molar weights of up to 400,

and at least one compound selected from

A4) compounds which have at least one ionic or potentially ionic group and/or

A5) nonionically hydrophilicized compounds.

A potentially ionic group for the purposes of the invention is a group which is capable of forming an ionic group.

The polyurethanes (A) are prepared preferably from 7 to 45% by weight of A1), from 50 to 91% by weight of A2), from 0 to 15% by weight of A5), from 0 to 12% by weight of ionic or potentially ionic compounds A4) and also optionally from 0 to 30% by weight of compounds A3), the sum of A4) and A5) being from 0.1 to 27% by weight and the sum of the components adding up to 100% by weight.

The polyurethanes (A) are prepared more preferably from 10 to 30% by weight of A1), from 65 to 90% by weight of A2), from 0 to 10% by weight of A5), from 3 to 9% by weight of ionic or potentially ionic compounds A4) and also optionally from 0 to 10% by weight of compounds A3), the sum of A4) and A5) being from 0.1 to 19% by weight and the sum of the components adding up to 100% by weight.

The polyurethanes (A) are prepared very preferably from 8 to 27% by weight of A1), from 65 to 85% by weight of A2), from 0 to 8% by weight of A5), from 3 to 8% by weight of ionic or potentially ionic compounds A4) and also optionally from 0 to 8% by weight of compounds A3), the sum of A4) and A5) being from 0.1 to 16% by weight and the sum of the components adding up to 100% by weight.

Suitable polyisocyanates (A1) are aromatic, araliphatic, aliphatic or cycloaliphatic polyisocyanates. Mixtures of such polyisocyanates can also be used. Examples of suitable polyisocyanates are butylene diisocyanate, hexamethylene diisocyanate (HDI), isophorone diisocyanate (IPDI), 2,2,4 and/or 2,4,4-trimethylhexamethylene diisocyanate, the isomeric bis(4,4′-isocyanatocyclohexyl)methanes or their mixtures of any desired isomer content, isocyanatomethyl-1,8-octane diisocyanate, 1,4-cyclohexylene diisocyanate, 1,4-phenylene diisocyanate, 2,4- and/or 2,6-tolylene diisocyanate, 1,5-naphthylene diisocyanate, 2,4′- or 4,4′-diphenylmethane diisocyanate, triphenylmethane 4,4′,4″-triisocyanate or derivatives thereof with a urethane, isocyanurate, allophanate, biuret, uretdione, iminooxadiazinedione structure and mixtures thereof. Preference is given to hexamethylene diisocyanate, isophorone diisocyanate and the isomeric bis(4,4′-isocyanatocyclohexyl)methanes and to mixtures thereof.

They are preferably polyisocyanates or polyisocyanate mixtures of the stated type having exclusively aliphatically and/or cycloaliphatically bonded isocyanate groups. Very preferred starting components (A1) are polyisocyanates and/or polyisocyanate mixtures based on HDI, IPDI and/or 4,4′-diisocyanatodicyclohexylmethane.

Also suitable as polyisocyanates (A1) are any desired polyisocyanates prepared by modification of simple aliphatic, cycloaliphatic, araliphatic and/or aromatic diisocyanates, synthesized from at least two diisocyanates and having a uretdione, isocyanurate, urethane, allophanate , biuret, iminooxadiazinedione and/or oxadiazinetrione structure, as described, for example, in J. Prakt. Chem. 336 (1994) pp. 185-200.

Suitable polymeric polyols or polyamines (A2) possess an OH functionality of at least 1.5 to 4, such as polyacrylates, polyesters, polylactones, polyethers, polycarbonates, polyestercarbonates, polyacetals, polyolefins and polysiloxanes, for example. Polyols in a molar weight range from 600 to 2500 with an OH functionality of from 2 to 3 are preferred.

The suitable hydroxyl-containing polycarbonates are obtainable by reacting carbonic acid derivatives, for example diphenyl carbonate, dimethyl carbonate or phosgene, with diols. Suitable such diols are, for example, ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-tri-methylpentane-1,3-diol, dipropylene glycol, polypropylene glycols, dibutylene glycol, polybutylene glycols, bisphenol A, tetrabromobisphenol A but also lactone-modified diols. The diol component preferably contains from 40 to 100% by weight of hexanediol, preferably 1,6-hexanediol and/or hexanediol derivatives, preferably those which as well as terminal OH groups contain ether groups or ester groups, e.g. products obtained by reacting 1 mol of hexanediol with at least one 1 mol, preferably 1 to 2 mol, of caprolactone in accordance with DE-A 17 70 245 or by etherifying hexanediol with itself to give the di- or trihexylene glycol. The preparation of such derivatives is known for example from DE-A 15 70 540. It is also possible to use the polyether-polycarbonate diols described in DE-A 37 17 060.

The hydroxyl polycarbonates should preferably be linear. They may, however, optionally have a low level of branching, through the incorporation of polyfunctional components, especially low molecular mass polyols. Examples of those suitable for this purpose include glycerol, trimethylolpropane, 1,2,6-hexanetriol, 1,2,4-butane-triol, trimethylolpropane, pentaerythritol, quinitol, mannitol, and sorbitol, methyl glycoside, and 1,3,4,6-dianhydrohexitols.

Suitable polyetherpolyols are the polytetramethylene glycol polyethers known per se in polyurethane chemistry, which can be prepared, for example, by polymerization of tetrahydrofuran, by means of cationic ring opening.

Further suitable polyetherpolyols are polyethers, such as the polyols prepared, using starter molecules, from styrene oxide, propylene oxide, butylene oxides or of epichlorohydrin, especially of propylene oxide.

Examples of suitable polyesterpolyols include reaction products of polyhydric, preferably dihydric and optionally additionally trihydric alcohols with polybasic, preferably dibasic carboxylic acids. Instead of the free polycarboxylic acids it is also possible to use the corresponding polycarboxylic anhydrides or corresponding polycarboxylic esters of lower alcohols or mixtures thereof to prepare the polyesters. The polycarboxylic acids can be aliphatic, cycloaliphatic, aromatic and/or heterocyclic in nature and can optionally be substituted, by halogen atoms for example, and/or unsaturated.

The components (A3) are suitable for terminating the polyurethane prepolymer. They include, suitably, monofunctional alcohols and monoamines. Preferred monoalcohols are aliphatic monoalcohols having 1 to 18 carbon atoms, such as ethanol, n-butanol, ethylene glycol monobutyl ether, 2-ethylhexanol, 1-octanol, 1-dodecanol or 1-hexadecanol, for example. Preferred monoamines are aliphatic monoamines, such as diethylamine, dibutylamine, ethanolamine, N-methylethanolamine or N,N-diethanolamine and amines of the Jeffamin® M series (Huntsman Corp. Europe, Belgium) or amino-functional polyethylene oxides and polypropylene oxides, for example.

Likewise suitable as components (A3) are polyols, aminopolyols or polyamines having a molar weight of below 400, which are described in large number in the corresponding literature.

Examples of preferred components (A3) are:

a) alkanediols and/or -triols, such as ethanediol, 1,2- and 1,3-propanediol, 1,4- and 2,3-butanediol, 1,5-pentanediol, 1,3 dimethylpropanediol, 1,6-hexanediol, neopentyl glycol, 1,4-cyclohexanedimethanol, 2-methyl-1,3-propanediol, 2-ethyl-2-butylpropanediol, trimethylpentanediol, positionally isomeric diethyloctanediols, 1,2- and 1,4-cyclohexanediol, hydrogenated bisphenol A [2,2-bis(4-hydroxycyclohexyl)propane], 2,2-dimethyl-3-hydroxypropyl 2,2-dimethyl-3-hydroxypropionate, trimethylolethane, trimethylolpropane or glycerol,

b) etherdiols, such as diethylene diglycol, triethylene glycol, tetraethylene glycol, dipropylene glycol, tripropylene glycol, 1,3-butylene glycol or hydroquinone dihydroxyethyl ether,

c) esterdiols of the general formulae (I) and (II),

HO—(CH₂)ₓ—CO—O—(CH₂)_{y}—OH (I),

HO—(CH₂)ₓ—O—CO-R—CO—O(CH₂)ₓ—OH (II),

in which

R is an alkylene or arylene radical having 1 to 10 carbon atoms, preferably 2 to 6 carbon atoms,

x is from 2 to 6 and

y is from 3 to 5,

such as, for example, δ-hydroxybutyl-ε-hydroxy-caproic esters, ω-hydroxyhexyl-γ-hydroxybutyric esters, (β-hydroxyethyl) adipate and (β-hydroxyethyl) terephthalate, and

d) diamines and polyamines such as 1,2-diaminoethane, 1,3 diaminopropane, 1,6-diaminohexane, 1,3- and 1,4-phenylenediamine, 4,4′-diphenylmethane-diamine, isophoronediamine, isomer mixture of 2,2,4- and 2,4,4-tri-methylhexamethylenediamine, 2-methylpentamethylenediamine, di-ethylenetriamine, 1,3- and 1,4-xylylenediamine, α,α,α′,α′-tetramethyl-1,3- and 1,4-xylylenediamine, 4,4-diaminodicyclohexylmethane, amino-functional polyethylene oxides or polypropylene oxides, which are obtainable under the name Jeffamin®, D series (Huntsman Corp. Europe, Belgium), diethylenetriamine and triethylenetetramine. Also suitable as diamines in the sense of the invention are hydrazine, hydrazine hydrate and substituted hydrazines, such as N-methylhydrazine, N,N′-dimethylhydrazine and their homologues and also acid dihydrazides, adipic acid, β-methyladipic acid, sebacic acid, hydracrylic acid and terephthalic acid, semicarbazido-alkylene hydrazides, such as β-semicarbazidopropionic hydrazide (e.g. described in DE-A 17 70 591), semicarbazidoalkylene-carbazine esters, such as 2-semicarbazidoethyl carbazine ester (e.g. described in DE-A 19 18 504) or else amino semicarbazide compounds, such as β-aminoethyl semicarbazido-carbonate (e.g. described in DE-A 19 02 931).

Component (A4) contains ionic groups, which may be either cationic or anionic in nature. Cationically, anionically dispersing compounds are those which, for example, sulphonium, ammonium, phosphonium, carboxylate, sulphonate, phosphonate groups or the groups which can be converted into the aforementioned groups by salt formation (potentially ionic groups) and can be incorporated into the macromolecules by existing isocyanate-reactive groups. Isocyanate-reactive groups of preferential suitability are hydroxyl groups and amine groups.

Examples of suitable ionic or potentially ionic compounds (A4) are mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-amino-ethylamino)ethanesulphonic acid, ethylene-diamine-propyl- or -butylsulphonic acid, 1,2- or 1,3-propylenediamine-β-ethyl-sulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and also building blocks which can be converted into cationic groups, such as N-methyldiethanolamine, as hydrophilic synthesis components. Preferred ionic or potential ionic compounds are those which possess carboxy or carboxylate and/or sulphonate groups and/or ammonium groups. Particularly preferred ionic compounds are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Examples of suitable nonionically hydrophilicizing compounds (A5) are polyoxyalkylene ethers containing at least one hydroxyl or amino group. These polyethers include a fraction of from 30% by weight to 100% by weight of building blocks derived from ethylene oxide. Suitability is possessed by polyethers of linear construction with a functionality of between 1 and 3, but also by compounds of the general formula (III),

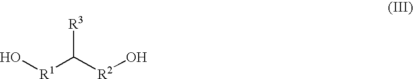

in which

R¹ and R² independently of one another are each a divalent aliphatic, cycloaliphatic or aromatic radical having 1 to 18 carbon atoms which may be interrupted by oxygen and/or nitrogen atoms, and

R³ is an alkoxy-terminated polyethylene oxide radical.

Further examples of nonionically hydrophilicizing compounds include monofunctional polyalkylene oxide polyether alcohols containing on average per molecule from 5 to 70, preferably from 7 to 55 ethylene oxide units, such as are obtainable in a manner known per se by alkoxylating suitable starter molecules (e.g. in Ullmanns Encyclopädie der technischen Chemie, 4th edition, volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers such as diethylene glycol monobutyl ether, for example, unsaturated alcohols such as allyl alcohol, 1,1-dimethylallyl alcohol or oleyl alcohol, aromatic alcohols such as phenol, the isomeric cresols or methoxy-phenols, araliphatic alcohols such as benzyl alcohol, anisyl alcohol or cinnamyl alcohol, secondary monoamines such as dimethylamine, diethylamine, dipropylamine, diisopropylamine, dibutylamine, bis-(2-ethylhexyl)amine, N-methyl- and N-ethylcyclohexylamine or dicyclohexylamine and also heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides particularly suitable for the alkoxylation reaction are ethylene oxide and propylene oxide, which can be used in either order or else in a mixture in the alkoxylation reaction.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide and not more than 60 mol % propylene oxide units.

To prepare the polyurethanes (A) it is preferred to use a combination of nonionic (A4) and ionic (A5) hydrophilicizing agents. Combinations of nonionic and anionic hydrophilicizing agents are particularly preferred.

The aqueous polyurethane (A) can be prepared in one or more stages in homogeneous phase or, in the case of multi-stage reaction, partly in disperse phase. Polyaddition, carried out to completion or partially, is followed by a dispersing, emulsifying or dissolving step. Subsequently they may be a further polyaddition or modification in disperse phase.

The polyurethane (A) can be prepared by any of the techniques known from the prior art, such as emulsifier/shearing force, acetone, prepolymer mixing, melt emulsification, ketimine and spontaneous solids dispersing techniques or modifications thereof. A compilation of these methods can be found in Methoden der organischen Chemie (Houben-Weyl, additional and supplementary volumes to the 4th edition, volume E20, H. Bartl and J. Falbe, Stuttgart, N.Y., Thieme 1987, pp. 1671-1682). Preference is given to the melt emulsification, prepolymer mixing and acetone techniques. The acetone technique is particularly preferred.

Normally the constituents (A2) to (A5) that contain no primary or secondary amino groups, and a polyisocyanate (A1) for the preparation of a polyurethane prepolymer, are charged in whole or in part to the reactor and diluted where appropriate with a water-miscible but isocyanate-inert solvent, but preferably without solvent, and heated to relatively high temperatures, preferably in the range from 50 to 120° C.

Examples of suitable solvents include acetone, butanone, tetrahydrofuran, dioxane, acetonitrile, dipropylene glycol dimethyl ether and 1-methyl-2-pyrrolidone, which can be added not only at the beginning of the preparation but also, where appropriate, in portions later on as well. Acetone and butanone are preferred. It is possible to conduct the reaction under atmospheric pressure or elevated pressure, e.g. above the atmospheric pressure boiling temperature of a solvent such as acetone, for example.

It is also possible for the catalysts known to accelerate the isocyanate addition reaction, such as triethylamine, 1,4-diazabicyclo-[2.2.2]octane, dibutyltin oxide, tin dioctoate or dibutyltin dilaurate, tin bis(2-ethylhexanoate) or other organometallic compounds, for example, to be included in the initial charge or metered in later. Dibutyltin dilaurate is preferred.

Subsequently any constituents (A1), (A2), optionally (A3) and (A4) and/or (A5) not added at the beginning of the reaction, and containing no primary or secondary amino groups, are added. In the case of the preparation of the polyurethane prepolymer the molar ratio of isocyanate groups to isocyanate-reactive groups is from 0.90 to 3, preferably from 0.95 to 2.5, more preferably from 1.05 to 2.0. The reaction of the components (A1) to (A5) takes place partly or completely, but preferably completely, based on the total amount of isocyanate-reactive groups of the fraction of (A2) to (A5) but contains no primary or secondary amino groups. The degree of reaction is normally monitored by following the NCO content of the reaction mixture. For this purpose it is possible to perform spectroscopic measurements, e.g. infrared or near infrared spectra, determinations of the refractive index, or chemical analyses, such as titrations, on samples taken. Polyurethane prepolymers containing free isocyanate groups are obtained, in bulk or in solution.

The preparation of the polyurethane prepolymers from (A1) and (A2) to (A5) is followed or accompanied, if not already carried out in the starting molecules, by the partial or complete formation of salts from the anionically and/or cationically dispersing groups. In the case of anionic groups this is done using bases such as ammonia, ammonium carbonate or ammonium hydrogencarbonate, trimethylamine, triethylamine, tributylamine, diisopropylethylamine, dimethylethanolamine, diethylethanolamine, triethanolamine, potassium hydroxide or sodium carbonate, preferably triethylamine, triethanolamine, dimethylethanolamine or diisopropylethylamine. The molar amount of the bases is between 50 and 100%, preferably between 60 and 90% of the molar amount of the anionic groups. In the case of cationic groups dimethyl sulphate or succinic acid are used. Where only nonionically hydrophilicized compounds (A5) with ether groups are used, the neutralization step is absent. Neutralization can also take place simultaneously with dispersion, with the dispersing water already containing the neutralizing agent.

Possible aminic components are (A2), (A3) and (A4) with which any remaining isocyanate groups can be reacted. This chain extension can be carried out either in solvent prior to dispersing, during dispersing, or in water after dispersing. Where aminic components are used as (A4), chain extension takes place preferably prior to dispersing.

The aminic component (A2), (A3) or (A4) can be added in dilution in organic solvents and/or in water to the reaction mixture. It is preferred to use from 70 to 95% by weight of solvent and/or water. Where two or more aminic components are present the reaction can take place in succession in any order or simultaneously, by addition of a mixture.

In order to prepare the polyurethane dispersion (A) the polyurethane prepolymers, optionally with strong shearing, such as strong stirring, for example, either are introduced into the dispersing water or, conversely, the dispersing water is stirred into the prepolymers. Subsequently, if this has not already taken place in the homogeneous phase, the molar mass can be raised by reacting any isocyanate groups present with component (A2), (A3). The amount of polyamine (A2), (A3) used depends on the unreacted isocyanate groups still present. It is preferred to react from 50 to 100%, more preferably from 75 to 95%, of the molar amount of the isocyanate groups with polyamines (A2), (A3).

If desired, the organic solvent can be removed by distillation. The dispersions have a solids content of from 10 to 70% by weight, preferably from 25 to 65% by weight and more preferably from 30 to 60% by weight.

Suitable blocked polyisocyanates (B) are prepared by reacting

(B1) at least one polyisocyanate having aliphatically, cycloaliphatically, araliphatically and/or aromatically bonded isocyanate groups but containing no hydrophilic groups with

(B2) at least one blocking agent.

The blocked polyisocyanates (B) may optionally comprise solvents (3).

Suitable polyisocyanates (B1) for preparing the blocked polyisocyanates (B) are polyisocyanates synthesized from at least two diisocyanates, by modifying simple aliphatic, cycloaliphatic, araliphatic and/or aromatic diisocyanates, with a uretdione, isocyanurate, allophanate, biuret, iminooxadiazinedione and/or oxadiazinetrione structure, as described, by way of example, in, for example, J. Prakt. Chem. 336 (1994) page 185-200.

Diisocyanates suitable for preparing the polyisocyanates (B1) are diisocyanates of the molecular weight range from 140 to 400 which are obtainable by phosgenation or by phosgene-free processes, for example by thermal urethane cleavage, and which have aliphatically, cycloaliphatically, araliphatically and/or aromatically bonded isocyanate groups, such as 1,4-diisocyanatobutane, 1,6-diisocyanatohexane (HDI), 2-methyl- 1,5-diisocyanatopentane, 1,5-diisocyanato-2,2-dimethylpentane, 2,2,4- and and/or 2,4,4-trimethyl- 1,6-diisocyanatohexane, 1,10-diisocyanatodecane, 1,3- and 1,4-diiso-cyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanato-methyl-cyclohexane, bis-(isocyanatomethyl)norbornane, 1,3- and 1,4-bis(2-isocyanatoprop-2-yl)benzene (TMXDI), 2,4- and 2,6-diisocyanatotoluene (TDI), 2,4′- and 4,4′-diiso-cyanatodiphenylmethane, 1,5-diisocyanatonaphthalene or any desired mixtures of such diisocyanates.

Also suitable, moreover, are triisocyanates such as triphenylmethane 4,4′,4′-tri-isocyanate and/or 4-isocyanatomethyl-1,8-octane diisocyanate.

The starting components (B1) are preferably polyisocyanates or polyisocyanate mixtures of the type stated, containing exclusively aliphatically and/or cyclo-aliphatically bonded isocyanate groups.

Particularly preferred starting components (B1) are polyisocyanates or polyisocyanate mixtures with an isocyanurate and/or biuret structure, based on HDI, IPDI and/or 4,4′-diisocyanatodicyclohexylmethane.

The polyisocyanates (B1) have an NCO content of from 1% to 50%, preferably from 8% to 25%. They may if desired be diluted with a water-miscible but isocyanate-inert solvent.

The polyisocyanates (B1) used to prepare the blocked polyisocyanates (B) have an (average) NCO functionality of from 2.0 to 5.0, preferably from 2.3 to 4.5, an isocyanate group content of from 1.0 to 50.0% by weight, preferably from 5.0 to 27.0% by weight and more preferably from 5.0 to 27.0% by weight from 14.0 to 24.0% by weight and a monomeric diisocyanate content of less than 1% by weight, preferably less than 0.5% by weight.

As an example of blocking agent (B2) mention may be made, for example, of alcohols, lactams, oximes, malonates, alkyl acetoacetates, triazoles, phenols, imidazoles, pyrazoles and amines, such as butanone oxime, diisopropylamine, 1,2,4-triazole, dimethyl-1,2,4-triazole, imidazole, diethyl malonate, ethyl acetoacetate, acetone oxime, ε-caprolactam, N-tert-butylbenzylamine, 3,5-dimethylpyrazole, or pyrazole derivatives of general formula (IV),

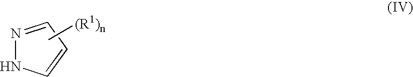

in which

R¹ corresponds to one or more (cyclo)aliphatic hydrocarbon radicals each having 1 to 12, preferably 1 to 4, carbon atoms, which contains no chemically bonded hydrophilic groups, and

n can be an integer from 0 to 3, preferably 1 or 2,

or any desired mixtures of these blocking agents.

Preference is given to using butanone oxime, compounds of the formula (IV), ε-caprolactam, N-tert-butylbenzylamine as blocking agents (B2). Particularly preferred blocking agent (B2) is 3,5-dimethylpyrazole or 3-methylpyrazole.

Suitable organic solvents (B3) are the paint solvents customary per se, such as ethyl acetate, butyl acetate, 1-methoxyprop-2-yl acetate, 3-methoxy-n-butyl acetate, acetone, 2-butanone, 4-methyl-2-pentanone, cyclohexanone, toluene, xylene, chloro-benzene or white spirit. Mixtures comprising aromatics particularly with relatively high degrees of substitution, such as are on the market, for example, under the designations solvent naphtha, Solvesso® (Exxon Chemicals, Houston, USA), Cypar® (Shell Chemicals, Eschborn, Del.), Cyclo Sol® (Shell Chemicals, Eschborn, Del.), Tolu Sol® (Shell Chemicals, Eschborn, Del.), Shellsol® (Shell Chemicals, Eschborn, Del.) are likewise suitable. Examples of further solvents are carbonic esters, such as dimethyl carbonate, diethyl carbonate, 1,2-ethylene carbonate and 1,2-propylene carbonate, lactones, such as β-propiolactone, γ-butyrolactone, ε-caprolactone, ε-methylcapro-lactone, propylene glycol diacetate, diethylene glycol dimethyl ether, dipropylene glycol dimethyl ether, diethylene glycol ethyl and butyl ether acetate, N-methyl-pyrrolidone and N-methylcaprolactam or any desired mixtures of such solvents. Preferred solvents are acetone, 2-butanone, 1-methoxyprop-2-yl acetate, xylene, toluene, mixtures comprising aromatics in particular having relatively high degrees of substitution, such as are on the market, for example, under the designations solvent naphtha, Solvesso® (Exxon Chemicals, Houston, USA), Cypar® (Shell Chemicals, Eschbom, Del.), Cyclo Sol® (Shell Chemicals, Eschborn, Del.), Tolu Sol® (Shell Chemicals, Eschbom, Del.), Shellsol® (Shell Chemicals, Eschbom, Del.) and N-methylpyrrolidone. Acetone, 2-butanone and N-methylpyrrolidone are particularly preferred.

The blocked polyisocyanates (B) are prepared by methods known in the art, the preparation being described for example in EP-A 0159117 (page 9-11).

The present invention likewise provides a process for preparing the aqueous (1K) coating systems of the invention, characterized in that the crosslinker component (B) is mixed into the polyurethane (A) prior to or during its transfer to the aqueous phase.

In one preferred embodiment the mixing of components (B) with component (A) takes place prior to the transfer to the aqueous phase and the mixture thus obtained is subsequently dispersed in water. In that case the polyurethane (A) serves as an emulsifier for the crosslinker (B), which has not been hydrophilically modified, and so holds it stably in the aqueous dispersion. Optionally it is also possible for there to be a chain extension step with component (A3) and/or (A4) in the aqueous dispersion.

The coating systems of the invention can be used alone or with the conventional coatings technology binders, auxiliaries and additives, especially light stabilizers such as UV absorbers and sterically hindered amines (HALS), and also antioxidants, fillers, and coatings auxiliaries, such as anti-settling agents, defoamers and/or wetting agents, levelling agents, reactive diluents, plasticizers, catalysts, auxiliary solvents and/or thickeners and additives, such as dispersions, pigments, dyes or dulling agents, for example. Combinations in particular with further binders such as polyurethane dispersions or polyacrylate dispersions, which where appropriate may also be hydroxy-functional, are possible without problems. The additives can be added to the coating system of the invention immediately prior to processing. It is also possible, however, to add at least a portion of the additives before or during the dispersing of the binder or binder/crosslinker mixture. The selection and the metering of these substances which can be added to the individual components and/or to the mixture as a whole are known to the person skilled in the art.

Even without the addition of auxiliaries, the removal of water from the coating compositions of the invention produces mechanically load-bearing coatings which are dust-dry to hard. The water can be removed by evaporation or forced drying, preferably at up to 100° C., by the action, for example, of heat, hot and/or dehumidified air and/or thermal radiation. Through subsequently thermally induced crosslinking at between 100 and 200° C., preferably between 110 and 180° C., which optionally also takes place with the substrate to which the coating has been applied, the films cure to particularly high-grade, water resistant and hydrolysis-resistant coatings.

The present specification likewise provides a process for producing coatings, characterized in that the aqueous coating system of the invention is applied to a substrate, the water is removed at least partially and then thermal curing is carried out.

The coating compositions of the invention can be applied to any of a wide variety of substrates by the usual techniques, such as by spraying, rolling, knifecoating, flow coating, squirting, brushing, or dipping, for example. Substrates are selected from the group consisting of wood, metal, plastic, paper, leather, textiles, felt, glass and mineral substrates. Preferred substrates are glass fibres or carbon fibres.

Substrates coated with the (1K) coating systems of the invention are likewise provided by the present invention.

The applied film thicknesses (before curing) are typically between 0.05 and 5000 μm, preferably between 0.05 and 1500 μm, more preferably between 0.05 and 1000 μm.

The invention also provides for the use of the aqueous (1K) coating systems of the invention in adhesives, sealants and paints and sizes, with their use in or as sizes, preferably glass fibre sizes, being preferred.

For the preparation of the sizing agents the (1K) coating compositions of the invention are used as binder components and may comprise further components such as emulsifiers, further film-forming resins, adhesion promoters, lubricants and auxiliaries such as wetting agents or antistats. The adhesion promoters, lubricants and auxiliaries, the process for preparing the sizing agents, and the process of sizing glass fibres and the subsequent working of the glass fibres are known and is described for example in K. L. Loewenstein “The Manufacturing Technology of Continuous Glass Fibres”, Elsevier Scientific Publishing Corp., Amsterdam, London, New York, 1983.

### EXAMPLES

| Products used: | |
|---|---|
| Desmodur ® W: | 4,4′-diisocyanatodicyclohexylmethane, Bayer AG, |
| | Leverkusen, DE |
| Desmodur ® I: | isophorone diisocyanate, Bayer AG, Leverkusen, DE |
| Desmodur ® H: | 1,6-hexamethylene diisocyanate, Bayer AG, Leverkusen, DE |
| Desmodur ® N3200: | polyisocyanate containing biuret groups and based on |
| | 1,6-diisocyanatohexane (HDI), having an NCO content of |
| | 23.0%, Bayer AG, Leverkusen, DE |
| Desmodur ® N3300: | polyisocyanate containing isocyanurate groups and based |
| | on 1,6-diisocyanatohexane (HDI), having an NCO content |
| | of 21.8%, Bayer AG, Leverkusen, DE |
| Desmodur ® VPLS 2376: | polyisocyanate containing isocyanurate groups and based |
| | on 1,6-diisocyanatohexane (HDI), blocked with 3,5-dimethylpyrazole |
| | (80% strength in methyl ethyl ketone), |
| | Bayer AG, Leverkusen, DE |
| Desmorapid ® SO: | tin 2-ethylhexanoate, Bayer AG, Leverkusen, DE |
| AAS: | 45% strength solution of the sodium salt of 2-(2-amino- |
| | ethylamino)ethanesulphonic acid, Bayer AG, Leverkusen, DE |
| Irganox ® 245 | ethylenebis(oxyethylene) bis[3-(5-tert-butyl-4-hydroxy-m- |
| | tolyl)propionate, Ciba Spezialitaten GmbH, Lampertheim, DE) |

The mechanical properties of the binders and coating compositions is determined on free films produced as follows:

A film applicator consisting of two polished rolls which can be set an exact distance apart has a release paper inserted into it ahead of the back roll. The distance between the paper and the front roll is adjusted using a feeler gauge. This distance corresponds to the wet film thickness of the resulting coating, and can be adjusted to the desired add-on of each coat. Coating can also be carried out consecutively in two or more coats. To apply the individual coatings, the products (aqueous formulations are adjusted to a viscosity of 4 500 mPa.s beforehand by addition of ammonia/polyacrylic acid) are poured onto the nip between the paper and the front roll, the release paper is pulled away vertically downwards, and the corresponding film is formed on the paper. Where two or more coats are to be applied, each individual coat is dried and the paper is reinserted.

The 100% modulus was determined in accordance with DIN 53504 on films greater than 100 μm thick.

Film storage under hydrolysis conditions takes place in accordance with DIN EN 12280-3. The mechanical properties of these film samples are determined after storage for 24 h under standard conditions (20° C. and 65% atmospheric humidity) in accordance with DIN 53504.

The mechanical film properties are determined after 30 minutes of drying at 150° C.

Blocked Polyisocyanates:

### Example 1

212.3 g of Desmodur® N3300 are introduced into a vessel with 130.5 g of methyl ethyl ketone and this initial charge is heated to 70° C. Subsequently 179.3 g of N-tert-butylbenzylamine are added dropwise with stirring over the course of 2 h and the reaction mixture is stirred at 70° C. until free isocyanate can no longer be detected by means of infrared spectroscopy.

### Example 2

249.5 g of Desmodur® N3300 are introduced into a vessel with 125.0 g of acetone. Subsequently 125.5 g of 3,5-dimethylpyrazole are added dropwise with stirring over the course of 2 h and the reaction mixture is stirred at 20° C. until free isocyanate can no longer be detected by means of infrared spectroscopy.

### Example 3

270.2 g of Desmodur® N3300 are introduced into a vessel with 130.7 g of methyl ethyl ketone and this initial charge is heated to 75° C. Subsequently 121.8 g of butanone oxime are added dropwise with stirring over the course of 2 h and the reaction mixture is stirred at 75° C. until free isocyanate can no longer be detected by means of infrared spectroscopy.

Dispersions:

### Example 4

169.9 g of the polyester PE 170 HN (Bayer AG, Leverkusen, DE, polyester based on adipic acid, neopentyl glycol and hexanediol, having an average molar weight of 1 700 (OHN=66)) and 77.8 g of polyether LB 25 (Bayer AG, Leverkusen, DE, monofunctional polyether based on ethylene oxide/propylene oxide, with an average molar weight of 2250 (OHN=25)) are introduced into a vessel and heated to 70° C. Then 50.9 g of Desmodur® are added over the course of 5 minutes at 20° C. with stirring, the reaction mixture is heated to 100° C. and is stirred at this temperature until the theoretical NCO value (2.17%) has been reached. After cooling to 50° C., the prepolymer is dissolved by adding 128.0 g of acetone over the course of 5 minutes. Following the addition of 156.5 g of the blocked polyisocyanate from Example 2 the reaction mixture is stirred for a further 5 minutes. Dispersing takes place by addition of 553.8 g of water (20° C.) over the course of 10 minutes. Dispersing is followed immediately by the metered addition, over the course of 5 minutes, of a solution of 1.0 g of hydrazine monohydrate, 6.8 g of isophoronediamine and 41.8 g of water at 40° C. The subsequent stirring time at 40° C. is 15 minutes. Removal of the solvent in vacuo gives a storage-stable aqueous PU/crosslinker dispersion which possesses blocked isocyanate groups, with a solids content of 40.6%. The average size of the dispersion particles is 164 nm.

### Example 5

169.9 g of the polyester PE 170 HN (Bayer AG, Leverkusen, DE, polyester based on adipic acid, neopentyl glycol and hexanediol, having an average molar weight of 1 700 (OHN=66)) and 77.8 g of polyether LB 25 (Bayer AG, Leverkusen, DE, monofunctional polyether based on ethylene oxide/propylene oxide, with an average molar weight of 2 250 (OHN=25)) are introduced into a vessel and heated to 70° C. Then 50.9 g of Desmodur® are added over the course of 5 minutes at 20° C. with stirring, the reaction mixture is heated to 100° C. and is stirred at this temperature until the theoretical NCO value (2.17%) has been reached. After cooling to 50° C., the prepolymer is dissolved by adding 128.0 g of acetone over the course of 5 minutes. Following the addition of 156.5 g of the blocked polyisocyanate Desmodur® VPLS 2376 the reaction mixture is stirred for a further 5 minutes. Dispersing takes place by addition of 553.8 g of water (20° C.) over the course of 10 minutes. Dispersing is followed immediately by the metered addition, over the course of 5 minutes, of a solution of 1.0 g of hydrazine monohydrate, 6.8 g of isophoronediamine and 41.8 g of water at 40° C. The subsequent stirring time at 40° C. is 15 minutes. Removal of the solvent in vacuo gives a storage-stable aqueous PU/crosslinker dispersion which possesses blocked isocyanate groups, with a solids content of 40.2%. The average size of the dispersion particles is 266 nm.

### Example 6

111.6 g of the polyether Desmophen® 3900 (Bayer AG, Lev., DE, trihydroxy-functional based on propylene oxide and ethylene oxide, having an average molar weight of 4 800 (OHN=35)), 11.9 g of polyether LB 25 (Bayer AG, Lev., DE, monofunctional polyether based on ethylene oxide/propylene oxide, with an average molar weight of 2 250 (OHN=25)) and 12.8 of polyethersulphonate are introduced into a vessel and heated to 70° C. Then 18.7 g of Desmodur® I, 14.2 g of Desmodur® H and 0.1 g of Desmorapid® SO are added over the course of 5 minutes at 70° C. with stirring. The reaction mixture is stirred at 70° C. until the theoretical NCO value (5.00%) has been reached. After cooling to 50° C., the prepolymer is dissolved by adding 314.1 g of acetone over the course of 5 minutes. Following the addition of 177.2 g of the blocked polyisocyanate from Example 2 and 5.0 g of Irganox® 245 the reaction mixture is stirred for a further 10 minutes. Dispersing takes place by addition of 489.4 g of water (20° C.) over the course of 5 minutes. Dispersing is followed immediately by the metered addition, over the course of 5 minutes, of a solution of 2.5 g of hydrazine monohydrate, 8.4 g of isophoronediamine and 205.2 g of water at 40° C. The subsequent stirring time at 40° C. is 15 minutes. Removal of the solvent in vacuo gives a storage-stable aqueous PU/crosslinker dispersion which possesses blocked isocyanate groups, with a solids content of 30.1%. The average size of the dispersion particles is 314 nm.

### Example 7

240.0 g of the polyester PE 170 HN (Bayer AG, Lev., DE, polyester based on adipic acid, neopentyl glycol and hexanediol, having an average molar weight of 1 700 (OHN=66)) and 8.1 g of polyether LB 25 (Bayer AG, Leverkusen, DE, monofunctional polyether based on ethylene oxide/propylene oxide, with an average molar weight of 2 250 (OHN=25)) are introduced into a vessel and heated to 65° C. Then 35.6 g of Desmodur® I and 26.9 g of Desmodur® H are added over the course of 5 minutes at 6° C. with stirring, the reaction mixture is heated to 110° C. and is stirred at this temperature until the theoretical NCO value (4.8%) has been reached. After cooling to 50° C., the prepolymer is dissolved by adding 552.0 g of acetone over the course of 5 minutes. Following the addition of 180.0 g of the blocked polyisocyanate Desmodur® VPLS 2376 the reaction mixture is stirred for a further 5 minutes. Prior to dispersion, a solution of 20.9 g of isophoronediamine and 37.1 g of acetone is metered in over the course of 2 minutes at 40° C. followed by a solution of 6.9 g of AAS, 0.7 g of hydrazine monohydrate and 36.2 g of water, metered in over the course of 5 minutes. The subsequent stirring time at 40° C. is 15 minutes. Dispersing takes place by addition of 619.6 g of water (20° C.) over the course of 35 minutes. Removal of the solvent in vacuo gives a storage-stable aqueous PU/crosslinker dispersion which possesses blocked isocyanate groups, with a solids content of 40.6%. The average size of the dispersion particles is 254 nm.

### Example 8

169.9 g of the polyester PE 170 HN (Bayer AG, Lev., DE, polyester based on adipic acid, neopentyl glycol and hexanediol, having an average molar weight of 1 700 (OHN=66)) and 77.8 g of polyether LB 25 (Bayer AG, Leverkusen, DE, monofunctional polyether based on ethylene oxide/propylene oxide, with an average molar weight of 2 250 (OHN=25)) are introduced into a vessel and heated to 70° C.

Then 50.9 g of Desmodur® W are added over the course of 5 minutes at 20° C. with stirring, the reaction mixture is heated to 100° C. and is stirred at this temperature until the theoretical NCO value (2.17%) has been reached. After cooling to 50° C., the prepolymer is dissolved by adding 128.0 g of acetone over the course of 5 minutes. Following the addition of 145.9 g of the blocked polyisocyanate from Example 3 the reaction mixture is stirred for a further 5 minutes. Dispersing takes place by addition of 544.6 g of water (20° C.) over the course of 10 minutes. Dispersing is followed immediately by the metered addition, over the course of 5 minutes, of a solution of 1.0 g of hydrazine monohydrate, 6.8 g of isophoronediamine and 41.8 g of water at 40° C. The subsequent stirring time at 40° C. is 15 minutes. Removal of the solvent in vacuo gives a storage-stable aqueous PU/crosslinker dispersion which possesses blocked isocyanate groups, with a solids content of 40.0%. The average size of the dispersion particles is 316 nm.

### Example 9

160.5 g of the polyester PE 170 HN (Bayer AG, Leverkusen, DE, polyester based on adipic acid, neopentyl glycol and hexanediol, having an average molar weight of 1 700 (OHN=66)) and 73.4 g of polyether LB 25 (Bayer AG, Lev., DE, monofunctional polyether based on ethylene oxide/propylene oxide, with an average molar weight of 2 250 (OHN=25)) are introduced into a vessel and heated to 70° C. Then 48.1 g of Desmodur® W are added over the course of 5 minutes at 20° C. with stirring, the reaction mixture is heated to 100° C. and is stirred at this temperature until the theoretical NCO value (2.17%) has been reached. After cooling to 50° C., the prepolymer is dissolved by adding 120.9 g of acetone over the course of 5 minutes. Following the addition of 175.5 g of the blocked polyisocyanate from Example 1 the reaction mixture is stirred for a further 5 minutes. Dispersing takes place by addition of 547.3 g of water (20° C.) over the course of 10 minutes. Dispersing is followed immediately by the metered addition, over the course of 5 minutes, of a solution of 0.9 g of hydrazine monohydrate, 6.4 g of isophoronediamine and 39.4 g of water at 40° C. The subsequent stirring time at 40° C. is 15 minutes. Removal of the solvent in vacuo gives a storage-stable aqueous PU/crosslinker dispersion which possesses blocked isocyanate groups, with a solids content of 40.6%. The average size of the dispersion particles is 329 nm.

### Example 10

### Comparative Example (Conventional Binder/Crosslinker System of the Prior Art)

126.0 g of Baybond® PU 401 (polyurethane dispersion, Bayer AG, Leverkusen, DE) and 74 g of a crosslinker dispersion prepared as follows are stirred at 20° C. for 30 minutes.

Crosslinker Dispersion:

147.4 g of a biuret-group-containing polyisocyanate based on 1,6-diisocyanato-hexane (HDI) with an NCO content of 23.0% is introduced into a vessel at 40° C. Over the course of 10 minutes 121.0 g of polyether LB 25 (Bayer AG, Lev., DE, mono-functional polyether based on ethylene oxide/propylene oxide, with an average molar weight of 2250 (OHN=25)) are metered in with stirring. Subsequently the reaction mixture is heated to 90° C. and is stirred at this temperature until the theoretical NCO value has been reached. After the mixture has cooled to 65° C. 62.8 g of butanone oxime are added dropwise over the course of 30 minutes with stirring at a rate such that the temperature of the mixture does not exceed 80° C. Dispersing takes place by addition of 726.0 g of water (T=20° C.) at 60° C. over the course of 30 minutes. The subsequent stirring time at 40° C. is 1 h.

This gives a storage-stable aqueous dispersion of the blocked polyisocyanate, having a solids content of 30.0%.

TABLE 1
Results of the inventive binders from Example 4-9 and of a
comparative binder of the prior art (Example 10) on the basis of
measurements of the mechanical properties on the free film

| | Example | | | | | | |
|---|---|---|---|---|---|---|---|
| | 4 | 5 | 6 | 7 | 8 | 9 | 10 |
| 100% modulus [MPa] | 0.7 | 0.7 | 6.5 | 1.2 | 0.8 | 2.1 | 0.9 |
| Tensile strength [MPa] | 2.5 | 2.3 | 11.7 | 8.4 | 2.8 | 3.4 | 6.1 |
| Elongation at break [%] | 360 | 300 | 190 | 870 | 330 | 170 | 690 |
| 1 week's hydrolysis | | | | | | | |
| Tensile strength [MPa] | 2.6 | 1.8 | 13.0 | 7.8 | 2.8 | 3.8 | has run |
| Elongation at break [%] | 400 | 330 | 220 | 900 | 240 | 210 | has run |
| 2 weeks' hydrolysis | | | | | | | |
| Tensile strength [MPa] | 3.0 | 2.0 | 12.8 | 8.0 | 3.3 | 3.4 | has run |
| Elongation at break [%] | 150 | 250 | 110 | 850 | 230 | 150 | has run |
| 4 weeks' hydrolysis | | | | | | | |
| Tensile strength [MPa] | n.d. | n.d. | n.d. | n.d. | 2.3 | 3.5 | has run |
| Elongation at break [%] | n.d. | n.d. | n.d. | n.d. | 160 | 220 | has run |
| 24 h H₂O | | | | | | | |
| Tensile strength [MPa] | n.d. | n.d. | n.d. | n.d. | 3.7 | 2.7 | 3.4 |
| Elongation at break [%] | n.d. | n.d. | n.d. | n.d. | 280 | 220 | 570 |
| Adhesion | | | | | | | |
| Dry [N/2.5 cm] | 13.0 | n.d. | n.d. | n.d. | 17.0 | 16.5 | 15.5 |
| Wet [N/2.5 cm] | 6.5 | n.d. | n.d. | n.d. | 13.0 | 7.5 | 5.5 |

n.d. = not determined

The results in Table 1 demonstrate that the dispersions of the invention, while having comparable mechanical properties (tensile strength and extensibility), are significantly superior to the binder-crosslinker mixture of the prior art in respect of hydrolysis resistance, water resistance and adhesion, especially wet adhesion.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous one-component (1K) coating systems comprising
(I) at least one polyurethane (A) which contains chemically bonded hydrophilic groups and from 0 to 0.53 mmol/g, based on the nonvolatile fraction of the dispersion, of groups containing Zerewitinov-active hydrogen atoms, and
(II) at least one polyisocyanate (B) in which the NCO groups have been reversibly blocked and which contains no hydrophilic groups, and
(III) water,
the proportion of components (A) and (B) being such that the blocked isocyanate content is between 0.01 and 1.0 mol/100 g resin solids.

2. The aqueous (1K) coating systems according to claim 1, wherein the polyurethane (A) is a reaction product of
A1) polyisocyanates,
A2) polymeric polyols and/or polyamines having number average molecular weights of from 400 to 8000,
A3) optionally mono- or polyalcohols or mono- or polyamines or amino alcohols having molecular weights of up to 400,
and at least one compound selected from
A4) compounds which have at least one ionic or potentially ionic group and
A5) nonionically hydrophilicized compounds.

3. The aqueous (1K) coating systems according to claim 1, wherein the polyurethane (A) includes as building blocks a combination of nonionic and ionic hydrophilicizing agents.

4. The aqueous (1K) coating systems according to claim 1, wherein the polyisocyanates (B) are prepared by reacting
(B1) at least one polyisocyanate having aliphatically, cycloaliphatically, araliphatically and/or aromatically bonded isocyanate groups containing no hydrophilic groups with
(B2) at least one blocking agent.

5. The aqueous (1K) coating systems according to claim 4, wherein the blocking agent for the isocyanate groups are pyrazole derivatives of the general formula (IV), 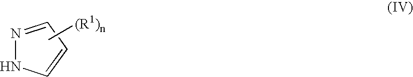
in which
R¹ corresponds to one or more (cyclo)aliphatic hydrocarbon radicals each having 1 to 12 carbon atoms, which contains no chemically bonded hydrophilic groups, and
n can be an integer from 0 to 3, preferably 1 or 2.

6. The aqueous (1K) coating systems according to claim 4, wherein the blocking agent is 3,5-dimethylpyrazole or 3-methylpyrazole.

7. A process for preparing aqueous the (1K) coating systems according to claim 1 comprising mixing component (B) into the polyurethane (A) prior to dispersing.

8. A process for producing coatings comprising applying the aqueous (1K) coating system according to claim 1 to a substrate, wherein the water is at least partly removed and then thermal curing is carried out.

9. The process for producing coatings according to claim 8, wherein the substrate is glass fibre or carbon fibre.

10. Substrates coated with a coating compositions comprising (1K) coating systems according to claim 1.

11. A method of sizing glass fibre comprising applying the aqueous (1K) coating systems according to claim 1 to glass fibre.

12. The aqueous (1K) coating systems according to claim 2, wherein the polyurethane (A) includes as building blocks a combination of nonionic and ionic hydrophilicizing agents.

13. The aqueous (1K) coating systems according to claim 2, wherein the polyisocyanates (B) are prepared by reacting
(B1) at least one polyisocyanate having aliphatically, cycloaliphatically, araliphatically and/or aromatically bonded isocyanate groups containing no hydrophilic groups with
(B2) at least one blocking agent.

14. The aqueous (1K) coating systems according to claim 5, wherein the blocking agent is 3,5-dimethylpyrazole or 3-methylpyrazole.

15. The aqueous (1K) coating systems according to claim 4, wherein the blocking agent for the isocyanate groups are pyrazole derivatives of the general formula (IV), 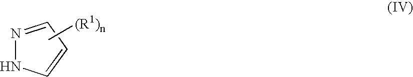
in which
R¹ corresponds to one or more (cyclo)aliphatic hydrocarbon radicals each having 1 to 12 carbon atoms, which contains no chemically bonded hydrophilic groups, and
n can be an integer from 0 to 3, preferably 1 or 2.

16. The aqueous (1K) coating systems according to claim 15, wherein the blocking agent is 3,5-dimethylpyrazole or 3-methylpyrazole.

17. The aqueous (1K) coating systems according to claim 3, wherein the polyisocyanates (B) are prepared by reacting
(B1) at least one polyisocyanate having aliphatically, cycloaliphatically, araliphatically and/or aromatically bonded isocyanate groups containing no hydrophilic groups with
(B2) at least one blocking agent.
